(19) United States
(12) Patent Application Publication
(10) Pub. No.: US 2007/0190868 A1
(43) Pub. Date: Aug. 16, 2007

(54) Outer Conductor Sleeve For A Coaxial Electrical Connector

(76) Inventors: Olivier De Cloet, Lorsch (DE); Wolfgang Mueller, Darmstadt (DE); Waldemar Stabroth, Mommenheim (DE)

Correspondence Address: BARLEY SNYDER, LLC, 1000 WESTLAKES DRIVE, SUITE 275, BERWYN, PA, 19312, US

(21) Appl. No.: 11/674,289

(22) Filed: Feb. 13, 2007

(30) Foreign Application Priority Data
Feb. 15, 2006 (DE) 102006006845.9

(51) Int. Cl. H01R 13/11

(52) U.S. Cl. 439/851

(57) ABSTRACT

An coaxial electrical connector sub-assembly having an outer conductor sleeve having a wall is substantially closed along a perimeter, a slot formed in the wall, and a spring finger integral with the wall and at least partially bounded by the slot, the spring finger having a free end configured to project into the outer conductor sleeve is disclosed.

### CROSS-REFERENCE TO RELATED APPLICATIONS

This application claims the benefit under 35 U.S.C. § 119(a)-(d) of foreign patent document DE 10 2006 006 845.9 filed Feb. 15, 2006.

### FIELD OF THE INVENTION

The invention relates to an outer conductor sleeve, and in particular, to an outer conductor sleeve for a right-angle plug coaxial electrical connector sub-assembly.

### BACKGROUND

Coaxial cables are the predominant type of cable used in many fields and applications, such as analog image transmission or digital communication in computer networks, as they are significantly less susceptible to interference than conventional cables and can transport significantly more data. Coaxial cables are being used increasingly, especially in the automotive field to create, for example, an electrical connection between the on-board network and a radio, a piece of GPS equipment, and mobile telephone installations. Coaxial cables and coaxial plug connections also have a wide range of applications in telecommunications, where they are used for a wide variety of connections in the base stations of mobile telecommunications networks.

Coaxial plug connections serve to electrically couple coaxial cables or to connect a coaxial cable to an electrical or electronic component or assembly. A coaxial cable substantially comprises two concentric conductors (inner and outer conductors), which are electrically insulated from each other via a dielectric. In the case of a coaxial plug connection, an inner conductor contact of the plug connection is electrically connected to the inner conductor of the coaxial cable and provides the lengthening of the signal transmission path. The coaxial plug connection also has an outer conductor contact, which is electrically connected to the cable outer conductor, usually copper wire mesh, and provides a connection to the earth or ground path.

The right-angle plug connection is a special case of the coaxial plug connection. In a right-angle plug connection, the connection with a mating connector does not take place in the direction of the longitudinal axis of the cable, but transversely thereto, usually at a right-angle. Such aright-angle plug connections are often used when a coaxial cable is to be connected for example to a mating connector that is fixedly mounted on a printed circuit board.

U.S. Pat. No. 4,426,127 discloses an electrical coaxial connection with an interior spring contact of a socket and a plurality of contact lamellae on the spring contact projecting freely inwards into a housing of the socket.

U.S. Pat. No. 5,562,506 discloses an electrical coaxial cable plug connection with a socket, the spring contact of which sits on a housing of the socket for an outer conductor of a coaxial cable. The spring contact has lamellae freely projecting from the spring contact, which are accommodated in housing slots when the socket is mounted.

U.S. Pat. No. 3,966,292 discloses an electrical coaxial cable plug connection with a socket, on the outer circumference of which a plurality of contact lamellae project freely. The contact lamellae extend substantially in an axial direction of the socket and are electrically connected to the outer conductor of a coaxial cable. The contact lamellae serve to electrically contact an outer contact of a plug, the outer contact of the plug being connected to the outer conductor of a second coaxial cable. Thus, an interior contact point of the inner conductor of the two coaxial cables is shielded.

One problem with contact lamellae projecting freely from the socket is that they have no protection against damage, for example during transportation and handling, or against over-expansion, for example when being connected to a mating connector. The contact lamellae also have sharp edges due to their manufacture (being punched from sheet metal), which can cause undesirable damage. For example, in the automotive field, the freely accessible lamellae may cause small tears to car seats when the sockets are placed on car seats. The small tears can lead to the appearance, especially of leather seats, being spoilt. Similarly, threads of car seat may repeatedly be pulled from fabric covers by the edges on the contact lamellae. These problems are further discussed below with reference to Prior Art FIG. 1.

DE 20 2004 004 829 U1 and U.S. Pat. Nos. 4,880,396, 5,533,914, and 6,129,585 each disclose linear slotted spring contacts for sockets, contact lamellae being provided in the wall of the spring contacts, each being formed by two adjacent slots. The contact lamellae are materially of one piece with the spring contacts at their respective longitudinal ends.

U.S. Pat. No. 5,088,942 discloses a socket for an electrical connection of two single-wire electrical connections, with a seamless contact body, which has a substantially cylindrical cavity and is accessible to a plug on one side. There is a socket spring, which is open on its circumference, inside the contact body, to electrically contact the plug. The socket spring has contact arms in a central portion, which protrude inwards into the socket spring and electrically contact the plug when it is inserted.

EP 0 236 824 A2 and DE 86 30 393 U1 disclose spring contacts for a contact sleeve of a coaxial connector, the respective spring contacts being defined by an approximately U-shaped through-recess in a wall of the contact sleeve and being located behind a web in the wall of the contact sleeve.

DE 103 15 042 A1 discloses a coaxial plug connector with an outer conductor terminal, which has two flexibly yielding contact parts diametrically opposite each other, protruding inwards into the outer conductor terminal. In this case, the contact parts are provided in a wall of the outer conductor terminal, are defined by a U-shaped through-recess in the wall and are located behind a web on the wall of the outer conductor terminal.

Prior Art FIG. 1 shows that the outer conductor sleeve 10 here substantially has two portions. The first, front portion, is constructed with spring fingers 120 which serve to electrically contact an outer face of a mating connector. The mating connector is inserted into the outer conductor sleeve 10 in an insertion direction S_{G} and pushed forward up to a central portion of the outer contact socket 10. The second portion of the outer conductor sleeve 10 has a contact sleeve 150, with which the outer conductor sleeve 10 can be fixed inside the electrical socket.

As can be seen clearly in Prior Art FIG. 1, the spring fingers 120 project freely from the contact sleeve 150 and extend substantially in an axial direction A of the outer conductor sleeve 10. In this embodiment, the spring fingers 120 are connected to the contact sleeve 150 of the outer conductor sleeve 10 and are materially of one piece therewith. Thus the spring fingers 120 are each movable substantially in a direction perpendicular to the axial direction A. In the case of the outer conductor sleeve 10, the spring fingers 120 are easily and freely accessible from outside and in unfavorable conditions, for example during transportation, handling of a mating connector or inexpert use of the electrical socket, the spring fingers 120 can be damaged or over-expanded, which can lead to an unusable electrical socket. The spring fingers 120 also have burrs or sharp edges resulting from their manufacture, and can cause damage to a surface when laid on or strafed against the surface. For example, the spring fingers 120 may pull threads out of fabric when removed from a surface covered in fabric.

### SUMMARY

The present invention relates to a coaxial electrical connector sub-assembly having an outer conductor sleeve having a wall is substantially closed along a perimeter, a slot formed in the wall, and a spring finger integral with the wall and at least partially bounded by the slot, the spring finger having a free end configured to project into the outer conductor sleeve.

### BRIEF DESCRIPTION OF THE DRAWINGS

Further details, advantages, and features of the present invention will become apparent from the following description of an exemplary embodiment together with the drawings, in which:

Prior Art FIG. 1 is an oblique view of an outer conductor sleeve according to the prior art;

Prior Art FIG. 2 is an oblique view of the outer conductor sleeve of FIG. 1;

FIG. 3 is an oblique view of a socket sub-assembly according to an embodiment of the present invention;

FIG. 4 is an oblique view of the socket sub-assembly 1 of FIG. 3;

FIG. 5 is an orthogonal cross-sectional view of the socket sub-assembly of FIG. 3;

FIG. 6 is an orthogonal view or the socket sub-assembly of FIG. 3;

FIG. 7 is an oblique view of an outer conductor sleeve of the socket sub-assembly of FIG. 3;

FIG. 8 is an oblique view of the outer conductor sleeve of FIG. 7;

FIG. 9 is an orthogonal view of the outer conductor sleeve of FIG. 7;

FIG. 10 is an orthogonal cross-sectional view taken at cutting line A-A of FIG. 9 of the outer conductor sleeve of FIG. 7;

FIG. 11 is an orthogonal cross-sectional view taken at cutting line B-B of FIG. 9 of the outer conductor sleeve of FIG. 7;

FIG. 12 is an orthogonal cross-sectional view taken at cutting line C-C of FIG. 9 of the outer conductor sleeve of FIG. 7;

FIG. 13 is an orthogonal cross-sectional view taken at cutting line D-D of FIG. 9 of the outer conductor sleeve of FIG. 7;

FIG. 14 is an orthogonal view of the outer conductor sleeve of FIG. 7;

FIG. 15 is an orthogonal cross-sectional view taken at cutting line E-E of FIG. 14 of the outer conductor sleeve of FIG. 7;

FIG. 16 is an orthogonal view of the outer conductor sleeve of FIG. 7;

FIG. 17 is an orthogonal cross-sectional view taken at cutting line F-F of FIG. 16 of the outer conductor sleeve of FIG. 7;

FIG. 18 is an oblique view of the outer conductor sleeve of FIG. 7;

FIG. 19 is an oblique view of an outer conductor sleeve according to another embodiment of the present invention;

FIG. 20 is an oblique view of the outer conductor sleeve of FIG. 19;

FIG. 21 is an orthogonal view of the outer conductor sleeve of FIG. 19;

FIG. 22 is an orthogonal cross-sectional view taken at cutting line A-A of FIG. 21 of the outer conductor sleeve of FIG. 19;

FIG. 23 is an orthogonal cross-sectional view taken at cutting line B-B of FIG. 21 of the outer conductor sleeve of FIG. 19;

FIG. 24 is an orthogonal cross-sectional view taken at cutting line C-C of FIG. 21 of the outer conductor sleeve of FIG. 19;

FIG. 25 is an orthogonal cross-sectional view taken at cutting line D-D of FIG. 21 of the outer conductor sleeve of FIG. 19;

FIG. 26 is an orthogonal view of the outer conductor sleeve of FIG. 19;

FIG. 27 is an orthogonal cross-sectional view taken at cutting line E-E of FIG. 26 of the outer conductor sleeve of FIG. 19;

FIG. 28 is an orthogonal view of the outer conductor sleeve of FIG. 19;

FIG. 29 is an orthogonal cross-sectional view taken at cutting line F-F of FIG. 28 of the outer conductor sleeve of FIG. 19; and

FIG. 30 is an oblique view of the outer conductor sleeve of FIG. 19.

### DETAILED DESCRIPTION OF THE EMBODIMENT(S)

Coaxial electrical connector is understood hereinafter to mean a coaxial socket and/or a coaxial plug. The same is the case for a sub-assembly of the coaxial socket and/or the coaxial plug, which is analogously called a coaxial electrical connector sub-assembly, for example coaxial socket sub-assembly 1.

The following configurations only relate to one outer conductor sleeve 10 of a coaxial socket sub-assembly 1, an inner conductor socket contact being insertable into the coaxial socket sub-assembly 1, counter to an insertion direction of an electrical mating connector, and thereby resulting in a coaxial socket. It is, however, also possible to insert an inner conductor pin contact into the coaxial socket sub-assembly 1, thus resulting in a coaxial electrical connector. It should be expressly pointed out here that a coaxial plug sub-assembly should also be included with a coaxial socket sub-assembly 1. Furthermore, the coaxial socket is described hereinafter as a socket and the coaxial plug as a plug.

Furthermore, the invention relates to an electrical socket with an electrical socket sub-assembly, the electrical socket sub-assembly having an inner conductor socket contact and/or an electrical plug with an electrical plug sub-assembly, the electrical plug sub-assembly having an inner conductor pin contact. The electrical socket and/or the electrical plug can be constructed as a right-angle socket or a right-angle plug in this case.

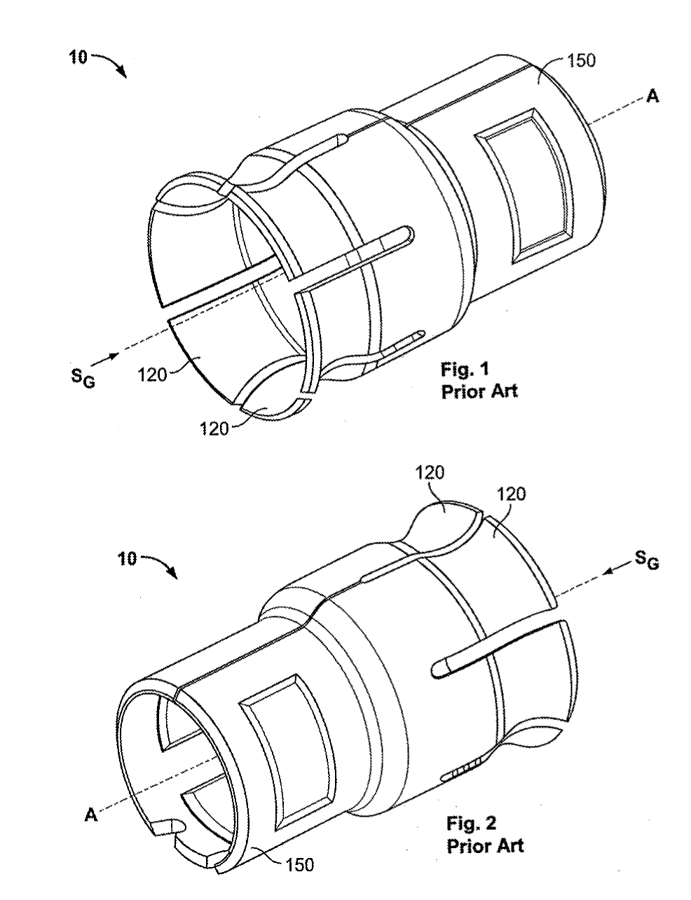

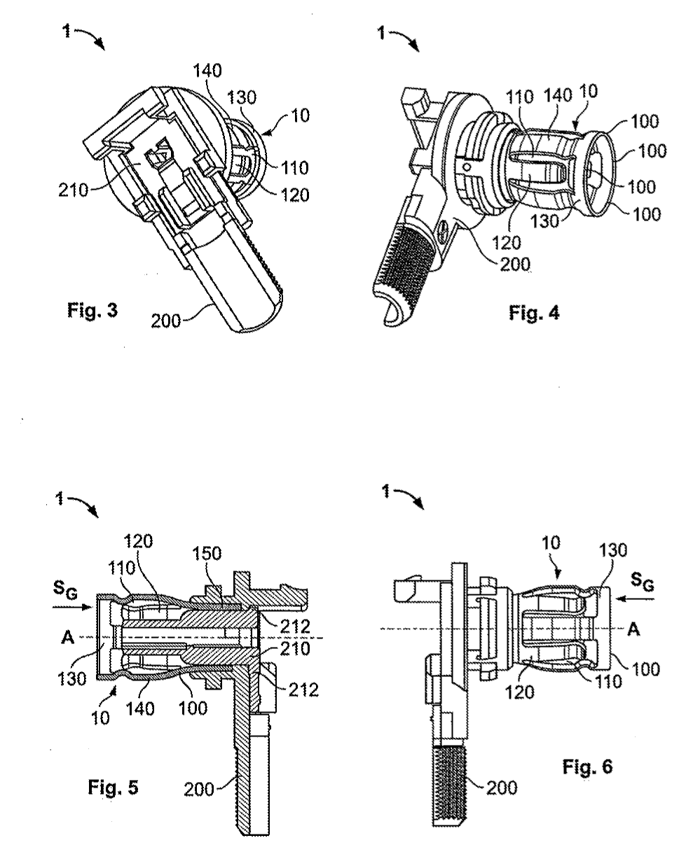

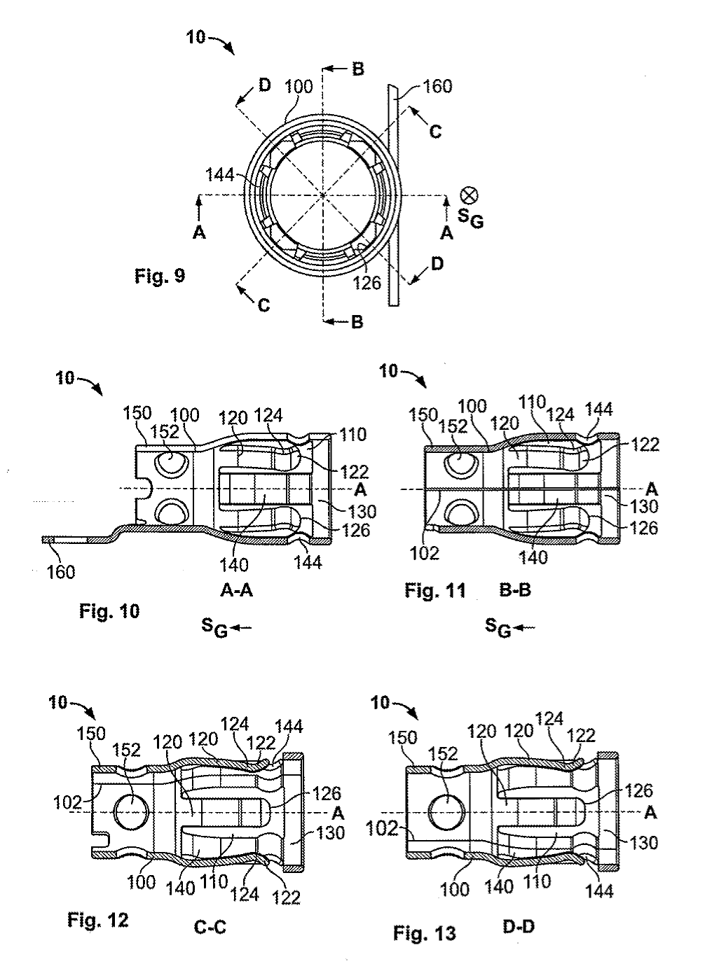

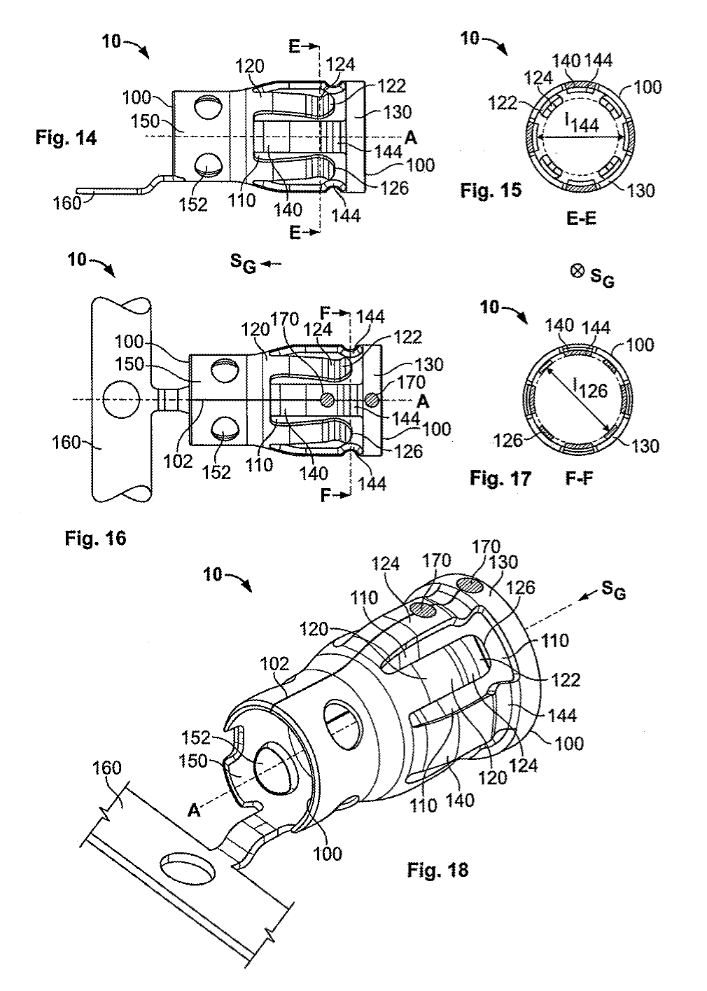

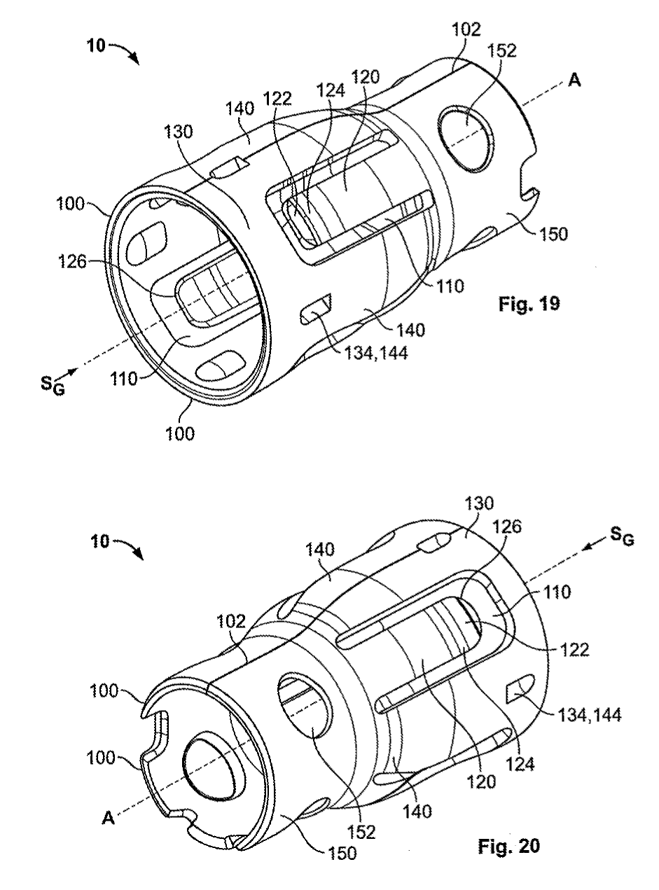

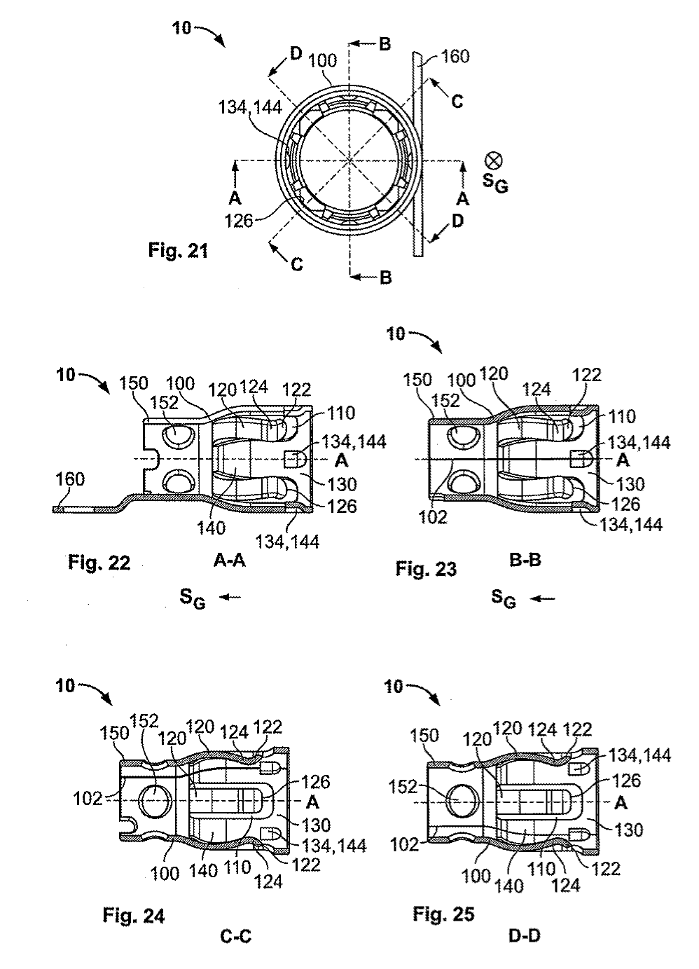

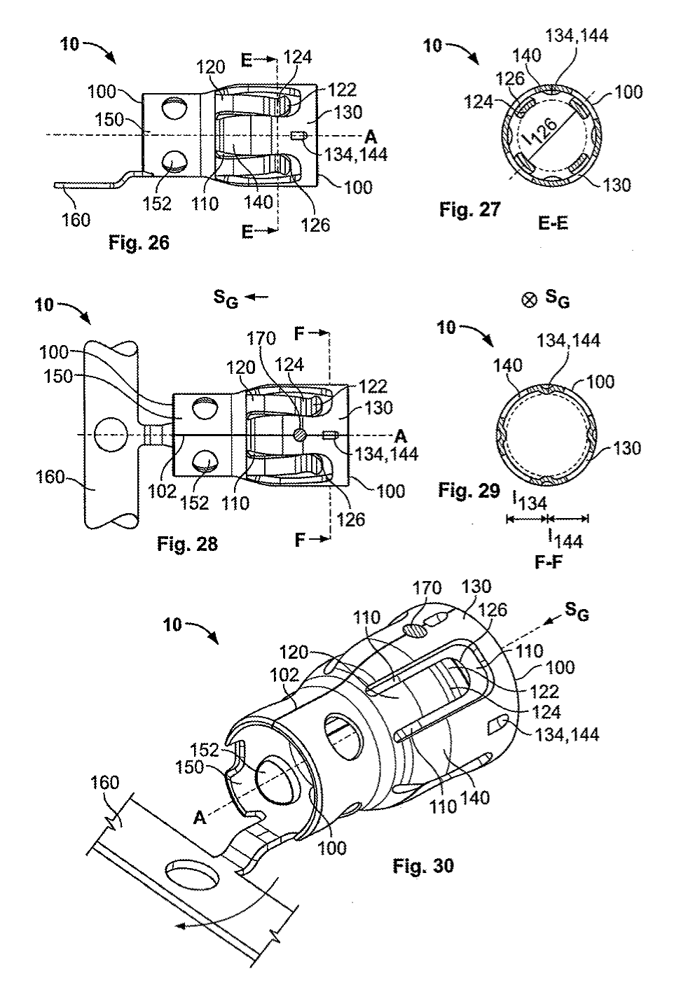

According to the present invention, damage caused by the spring fingers 120 is prevented in that the spring fingers 120, which are connected to the contact sleeve 150 on one side, are protected inside the outer conductor sleeve 10. The spring fingers 120 may be bent into the interior of the socket sub-assembly 1, so that no regions of the spring fingers 120 protrude outwards from a lateral surface of a finished socket. This is described in more detail hereinafter with reference to two exemplary embodiments, FIGS. 3-18 show the a first exemplary embodiment of the outer conductor sleeve 10 according to the present invention and FIGS. 19-30 show a second exemplary embodiment of the outer conductor sleeve 10 according to the present invention.

FIGS. 3 and 4 show an inner conductor socket contact or an inner conductor pin contact (then called electrical connector, see above also) is inserted into this rear portion of the socket sub-assembly 1 in the complete socket. The socket sub-assembly 1 may be manufactured and sold separately. A final assembly of the socket sub-assembly 1 to make a complete socket is not affected until performed by a customer, as various lengths of coaxial cable according to various applications are connected tightly and possibly unreleasably to the inner conductor socket contact, in order to ensure high endurance strength and good electrical connection.

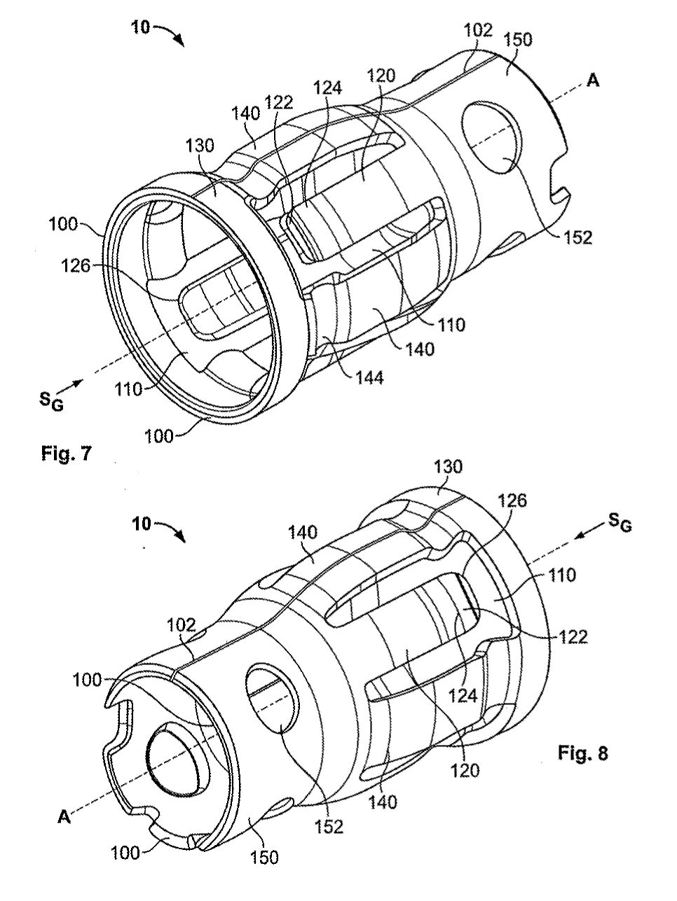

The socket sub-assembly 1 comprises a housing 200, a mount 210 inserted into the housing 200, and the outer conductor sleeve 10 accommodated between mount 210 and housing 200. The electrical socket sub-assembly 1 is configured as a right-angle plug connection, in which a cable (not shown) such as a coaxial cable, to be contacted via the socket, is accommodated inside the socket sub-assembly 1 substantially perpendicular to the insertion direction of the (counter to the insertion direction S_{G} of the mating connector). Protuberances 212, which project on the mount 210 radially outwards and/or on the housing 200 radially inwards, engage in apertures 152 (see FIG. 7-18) in the outer conductor sleeve 10, such that the outer conductor sleeve 10 with its contact sleeve 150 is accommodated tightly between the mount 210 and the housing 200. When the housing 200 of the socket sub-assembly 1 is completely assembled with its rear portion, it is no longer possible to pull the outer conductor sleeve 10 out of the electrical socket sub-assembly 1. Protuberances 212 on the mount 210, which rest against the inside of the housing 200, prevent the mount 210 from being pulled out of the housing 200 against the insertion direction S_{G} of the mating connector. The mounting of the outer conductor sleeve 10 inside the housing 200 and on the mount 210 is made easier by a slot 110 inside the outer conductor sleeve 10, which is located in the outer conductor sleeve 10 and gives the outer conductor sleeve 10 a certain amount of resilience in the region of the contact sleeve 150. The resilience in the region of the contact sleeve 150 is diminished when the outer conductor sleeve 10 is assembled in the socket sub-assembly 1. The actual inner conductor socket contact, which is to be contacted by the mating connector, is located inside the mount 210, and is electrically connected to a conductor of the cable such as the inner conductor of a coaxial cable.

The outer conductor sleeve 10 (see FIGS. 3-18 for the first embodiment and FIGS. 19-30 for the second embodiment) comprises a hollow cylindrical, cage-like configuration, the outer conductor sleeve 10 being substantially divided into three portions extending in an axial direction A of the outer conductor sleeve 10. These portions are, as seen in the insertion direction S_{G} of the mating connector, a front ring 130 which is integral with the outer conductor sleeve 10, spring fingers 120 and support arms 140 next to the ring 130, which are integral with the outer conductor sleeve 10. The spring fingers 120 and support arms 140 extend substantially in the axial direction A of the outer conductor sleeve 10 and the contact sleeve 150, which is integral with the outer conductor sleeve 10. The contact sleeve 150 allows connection of the outer conductor sleeve 10 and the electrical socket sub-assembly 1. Spring fingers 120, ring 130, and support arms 140 may all be connected materially of one piece to each other and form a substantially rotationally-symmetrical wall 100 of the outer conductor sleeve 10. The outer conductor sleeve 10 can thus be manufactured substantially in two operations, punching and subsequent bending.

The outer conductor sleeve 10 forms an outer contour in the socket sub-assembly 1 and in the socket during one of its uses. Alternatively, outer conductor sleeve 10 forms an outer region of the socket sub-assembly 1 or of the socket and is not provided inside an additional socket or casing, holding the outer conductor sleeve 10 together, for example.

The outer conductor sleeve 10 is closed on at least a perimeter (see weld point 170). In other words, there is at least a path on the outer conductor sleeve 10 over a whole perimeter which is not open at a stop 102 of the wall 100 of the outer conductor sleeve 10. This closed perimeter path may be located near the ring 130. In one embodiment, the outer conductor sleeve 10 can be closed at the stop 102 of the wall 100 in sections or even along the whole stop 102.

Starting from the hollow cylindrical contact sleeve 150, a plurality of spring fingers 120 and support arms 140 extend counter to the insertion direction S_{G} of the mating connector in the axial direction A of the outer conductor sleeve 10. The spring fingers 120 and support arms 140 are differentiated as spring fingers 120 are attached on one side while support arms 140 are attached on two sides. The spring fingers 120 are attached on one side have a free end 126 and serve to electrically contact the outer face of the mating connector; the support arms 140 are attached on two sides and are each constructed with the end opposite the contact sleeve 150 as an integral part of a ring 130. This means that the spring fingers 120 attached on one side are only rigidly connected at one longitudinal end to the outer conductor sleeve 10, whereas the support arms 140 are attached on two sides and are rigidly connected at both of their longitudinal ends to the outer conductor sleeve 10. The spring fingers 120 and the support arms 140 are arranged around the outer conductor sleeve 10 in the direction of the circumference at regular intervals and alternately to each other, and are substantially of strip-type construction. One single slot 110 delimits each spring finger 120 and support arm 140 on one longitudinal side or a lateral end. According to the invention, two straight portions of a single slot 110 are connected to each other via a curve, the curve partially delimiting the ring 130 inside the outer conductor sleeve 10. The two straight portions delimit two support arms 140 radially, directly adjacent to a respective bounded spring finger 120.

The spring fingers 120 and support arms 140 rise outwards from the curved casing of the contact sleeve 150 in the transition region of the contact sleeve 150 and the spring fingers 120 extend from it, and then in turn become a sleeve-shaped (hollow cylindrical) portion.

The spring fingers 120 are of crowned construction, with a support indentation 144 in their free longitudinal end portion 122, or with a protuberance 212 or similar structure, located inside the outer conductor sleeve 10, with which they electrically contact the outer face of the mating connector when connected with the mating connector (see below).

The support arms 140 and/or the ring 130 are likewise of crowned construction, with a ring indentation 134 and support indentation 144 in the transitional region of the support arms 140 and the ring 130, or with a protuberance projecting into the outer conductor sleeve 10. In another embodiment of the invention, these protuberances centering the mating connector are located at the front on the ring 130. In the first embodiment of the invention, the support indentation 144 in the support arms 140 runs in a radial direction over the whole width of each support arms 140. The spring indentation 124 in the spring fingers 120 also preferably runs radially over the whole width of the spring fingers 120.

The free sides of the spring fingers 120 are provided at a distance to the rest of the outer conductor sleeve 10. The two longitudinal sides of the spring fingers 120 are provided at a distance in relation to two directly adjacent support arms 140, and the free end of the spring fingers 120 are provided at a distance in relation to the ring 130. These gaps form a coherent, but not straight, slot 110 inside the outer conductor sleeve 10, where slot 110 is approximately U-shaped in both embodiments. However, in alternative embodiments, slot 110 may be approximately V-shaped or H-shaped.

All the spring fingers 120 of the outer conductor sleeve 10 are at least in part located inside the outer conductor sleeve 10. A large part of the whole of each spring finger 120 is located inside a corresponding outer diameter of the outer conductor sleeve 10. This can be seen particularly well in the sectional drawings C-C and D-D in FIGS. 12 and 24, and 13 and 25, respectively. It is also clear that the respective spring indentations 124 in the spring fingers 120 (shown in the insertion direction S_{G}) are located behind the ring indentations 134 and support indentations 144 in the ring 130 and the support arms 140.

The ring indentations 134 and support indentations 144 serve to center the outer face of the mating connector when the mating connector is inserted into the electrical socket. The actual electrical contact points, that is the spring indentations 124 of the spring fingers 120, of the outer conductor sleeve 10 are only touched, and thereby electrically contacted, when the mating connector is moved further forward. The respective free ends 126 or their longitudinal end regions mounted downstream (their free ends 126, among other parts) of the spring fingers 120 are bent outwards radially, so that the mating connector to be inserted into the electrical socket pushes the spring fingers 120 outwards radially and does not over-expand them or push them together.

A circle formed by the free ends 126 of the spring fingers 120 may be greater in diameter than a circle formed by the ring indentations 134 and support indentations 144 of the cage. These two circles are substantially coaxial in relation to the axial direction A of the outer conductor sleeve 10. As shown in the respective sectional rear views E-E and F-F in FIGS. 15 and 17, and 27 and 29, respectively, the inner diameter of the circle formed by the support indentations 144 of the support arms 140 being indicated by I₁₄₄, inscribed in the outer conductor sleeve 10. The inner diameter I₁₂₆ is the diameter of the circle formed by the free ends 126 of the spring fingers 120. I₁₂₆ is greater than I₁₄₄ here, which ensures that the mating connector pushes the spring fingers 120 radially apart after being centered by the ring indentations 134 and support indentations 144, and cannot over-expand or damage them. This applies similarly to the inner diameter I₁₃₄ (see below), which is formed by a circle defined by the ring indentations 134 on the ring 130. This ensures that the spring fingers 120 can neither be damaged nor over-expanded when the mating connector is inserted and this is advantageous for electrical sockets that are subject to a large number of insertion cycles.

The manufacture of the conductor sleeve 10 according to the invention takes place substantially in two manufacturing operations. Firstly, a blank of the outer conductor sleeve 10 extending in a plane is punched out of a suitable thin sheet of metal, and then bent into a round configuration in the second stage. The profiling of the sheet, or of the wall 100, can be done before or during the punching process, or before the bending round of the outer conductor sleeve 10. After the outer conductor sleeve 10 has been bent together, it is laser welded along the stop 102 that has been formed. This may be accomplished with a weld point 170, which is provided near the ring 130 (see FIGS. 18 and 30). The first embodiment of the invention has a weld point 170 on the ring 130 and another weld point 170 on a support arm 140, whereas the second embodiment of the invention only shows one single weld point 170 in the insertion direction S_{G}, behind a ring indentation 134 and support indentation 144. The stop 102 may not be welded in the region of the contact sleeve 150 or in a region of the support arms 140 located adjacent to the contact sleeve 150, in order to ensure a certain flexibility for the mounting of the outer conductor sleeve 10 on the mount 210 and in the housing 200. The outer conductor sleeve 10 is attached to a carrier 160 until after the laser welding, the carrier being detached before the assembly of the outer conductor sleeve 10 in the socket sub-assembly 1. The weld point may be provided near the ring on the outer conductor sleeve 10 so that the ring 130 cannot freely distort when the mating connector is inserted.

The second embodiment of the invention is substantially differentiated from the first, in that the support indentations 144 in the support arms 140 of the first embodiment no longer run along the whole radial extension of a single support arm 140, but rather are replaced by a smaller ring indentation 134 in the ring 130 and/or a support indentation 144 in the support arms 140. In the embodiment shown, the ring indentations 134 and support indentations 144 extend in the transitional region from the support arms 140 to the ring 130. The ring indentations 134 and support indentations 144 are provided centrally here in relation to the longitudinal extension of the support arms 140. In this embodiment, two support indentations 144 located directly next to each other can be provided on the inside of the support arms 140.

A plurality of spring fingers 120 and a plurality of support arms 140 may be constructed respectively in both embodiments. The number of spring fingers 120 is equal to the number of support arms 140 in this case. There is at least a spring finger 120 and a support arm 140 inside the outer conductor sleeve 10. There may be an even number of spring fingers 120 and support arms 140, for example, four of each.

The support arms 140 form a cage for the spring fingers 120, between which they are arranged and protected. The support arms 140 are preferably burr-free, at least on the outside. The ring 130, which represents a front boundary of the cage or is part of it, prevents damage caused by faulty areas. The ring 130 also serves to align the outer conductor sleeve 10 for contact with an electrical mating connector whereby if an angle of insertion between the outer conductor sleeve 10 and the electrical mating connector is oblique and too large, the electrical mating connector is obstructed from inappropriately aligned insertion by the ring 130. Incorporating the ring 130 provides a robust structure which eliminates the need to provide a housing around the socket sub-assembly 1, reducing the cost of the socket sub-assembly 1.

Furthermore, there may be four apertures 152 in the contact sleeve 150 and the apertures 152 may be spaced at regular intervals with their centers on a perimeter of the contact sleeve 150. These apertures 152 are each located with their center lines perpendicular to the axial direction A of the outer conductor sleeve 10.

An edge of ring indentations 134, support indentations 144, and end portions 122 of spring fingers 120 may be substantially curved in a manner effective for interfacing with the mating connector.

What is claimed is:

1. An outer conductor sleeve for a coaxial electrical connector sub-assembly, comprising:
an outer conductor sleeve having a wall is substantially closed along a perimeter; and
a slot formed in the wall; and
a spring finger integral with the wall and at least partially bounded by the slot, the spring finger having a free end configured to project into the outer conductor sleeve.

2. The outer conductor sleeve according to claim 1, further comprising:
a plurality of spring fingers extending substantially in an axial direction of the outer conductor sleeve;
wherein the slot is substantially U-shaped.

3. The outer conductor sleeve according to claim 1, further comprising:
a plurality of spring fingers extending substantially in an axial direction of the outer conductor sleeve;
wherein the slot is substantially V-shaped.

4. The outer conductor sleeve according to claim 1, further comprising:
a ring partially bounded by the slot and formed on an end of the outer conductor sleeve.

5. The outer conductor sleeve according to claim 4, further comprising:
a contact sleeve formed in the outer conductor sleeve; and
a support arm, at least partially bounded by the slot, connecting the ring to the contact sleeve.

6. The outer conductor sleeve according to claim 4, further comprising:
a support indentation projecting from the support arm into the outer conductor sleeve, the support indentations configured to align a mating connector with respect to the outer conductor sleeve.

7. The outer conductor sleeve according to claim 4, further comprising:
a plurality of ring indentations projecting from the ring and defining an inner diameter of the outer conductor sleeve;
wherein the inner diameter defined by the ring indentations is greater than a smallest inner diameter defined by the free ends of a plurality of spring fingers.

8. The outer conductor sleeve according to claim 7, further comprising:
a spring indentation, projecting from the spring finger into the outer conductor sleeve for electrically contacting a mating connector;
wherein the spring indentation is located, in an insertion direction, behind the ring indentations.

9. The outer conductor sleeve according to claim 4, further comprising:
a plurality of ring indentations projecting from the ring and defining an inner diameter of the outer conductor sleeve;
wherein the inner diameter defined by the ring indentations is substantially the same or slightly smaller than an inner diameter defined by the free ends of a plurality of spring fingers.

10. The outer conductor sleeve according to claim 4, further comprising:
a support indentation projecting from each of a plurality of support arms, the support indentations defining an inner diameter of the outer conductor sleeve;
wherein the inner diameter defined by the support indentations is greater than a smallest inner diameter defined by the free ends of a plurality of spring fingers.

11. The outer conductor sleeve according to claim 10, further comprising:
a spring indentation, projecting from the spring finger into the outer conductor sleeve for electrically contacting a mating connector;
wherein the spring indentation is located, in an insertion direction, behind the support indentations.

12. The outer conductor sleeve according to claim 4, further comprising:
a plurality of support indentations projecting from a plurality of support arms and defining an inner diameter of the outer conductor sleeve;
wherein the inner diameter defined by the support indentations is substantially the same or slightly smaller than an inner diameter defined by the free ends of a plurality of spring fingers.

13. The outer conductor sleeve according to claim 1, further comprising:
four spring fingers connected; and
four support arms, each at least partially bounded by at least one of a plurality of slots;
wherein the spring fingers and support arms alternate in a circumferential direction around the outer spring.

14. The outer conductor sleeve according to claim 1, wherein the outer conductor sleeve is punched from sheet metal and welded.

15. The outer conductor sleeve according to claim 14, further comprising:
a ring partially bounded by the slot and formed on an end of the outer conductor sleeve;
wherein a weld point is located on the ring.

16. The outer conductor sleeve according to claim 14, wherein the welding is laser welding.

17. The outer conductor sleeve according to claim 1, further comprising:
a contact sleeve formed in the outer conductor sleeve; and
an aperture for fixing outer conductor sleeve in a housing of the coaxial electrical connector sub-assembly.

18. The outer conductor sleeve according to claim 1, further comprising:
an inner conductor socket contact.

19. The outer conductor sleeve according to claim 1, further comprising:
an inner conductor pin contact.

20. The outer conductor sleeve according to claim 1, wherein the coaxial electrical connector sub-assembly is a right-angle coaxial electrical connector sub-assembly.
